(19) United States
(12) Patent Application Publication
(10) Pub. No.: US 2015/0134224 A1
(43) Pub. Date: May 14, 2015

(54) AUTOMOTIVE CRUISE CONTROLS, CIRCUITS, SYSTEMS AND PROCESSES

(71) Applicant: Texas Instruments Incorporated, Dallas, TX (US)

(72) Inventor: Anthony S. Vaughan, Vail, AZ (US)

(21) Appl. No.: 14/598,693

(22) Filed: Jan. 16, 2015

Related U.S. Application Data
(62) Division of application No. 12/775,768, filed on May 7, 2010.

(51) Int. Cl. B60W 30/14; B60W 10/10; B60W 10/184; B60W 10/04

(52) U.S. Cl. CPC B60W 30/143; B60W 10/04; B60W 10/10; B60W 10/184; B60W 2550/142; B60W 2520/16; B60W 2520/28; B60W 2520/30; B60W 2710/0611; B60W 2710/10; B60W 2710/105; B60W 2550/402; B60W 2550/406; B60W 2710/18
USPC 701/93

(57) ABSTRACT

A cruise control includes an input (225) for speed-related data, a hill angle sensor (230), and a cruise controller (210) having a throttling control output (215) and control conditions responsive to both the speed-related data and to the hill angle sensor (230) to determine whether to increase or decrease the throttling control output or leave the throttling control output unchanged. Other cruise control apparatus and processes and automotive vehicles are disclosed.

This application is a Divisional of prior application Ser. No. 12/775,768, filed May 7, 2010, currently pending.

### STATEMENT REGARDING FEDERALLY SPONSORED RESEARCH OR DEVELOPMENT

Not applicable.

### COPYRIGHT NOTIFICATION

Portions of this patent application contain materials that are subject to copyright protection. The copyright owner has no objection to the facsimile reproduction by anyone of the patent document, or the patent disclosure, as it appears in the United States Patent and Trademark Office, but otherwise reserves all copyright rights whatsoever.

### BACKGROUND

A conventional cruise control system may use the vehicle brakes or transmission to slow a vehicle as it moves down hill, which thereby dissipates energy and keeps the vehicle speed from going above the set point. This operation consumes and dissipates energy to slow the vehicle down. Automobiles suffer loss of fuel economy when the cruise control is used.

U.S. Patent Application Publication 20040084237, “Vehicle Cruise Control System” dated May 6, 2004, shows some background on a vehicle cruise control system with an upper set speed and a lower set speed.

“Measurement of the road gradient using an inclinometer mounted on a moving vehicle,” S. Mangan et al., 2002 IEEE International Symposium on Computer Aided Control System Design Proceedings, pp. 80-85, mentions automatic cruise control and provides some background on challenges of road gradient measurement.

U.S. Pat. No. 5,594,645 “Cruise controller for vehicles” Jan. 14, 1997 mentions various sensors.

It would be desirable to improve cruise control systems for full driver convenience, as well as fuel economy, reliability, simplicity, and low cost. These represent some of the problematic areas and desirable features in a cruise control.

It would be desirable to improve cruise control systems for gasoline or diesel powered internal combustion engine vehicles and also for hybrid gas/electric or electric only vehicles such as sedans, pickup trucks, trailer trucks, SUVs (sport utility vehicles), cross-overs, vans, RVs (recreation vehicles), motorcycles and other vehicles (where unaccompanied references herein to “car” or “vehicle” refers to any of them). It would be desirable to improve cruise control systems for vehicles with frictional brakes, such as drum brakes and/or disc brakes, as well as vehicles with regenerative braking.

Moreover, in this era of concern about automotive fuel economy, energy conservation greenhouse gas emissions, and green and eco-friendly technologies, improved cruise controls that can increase fuel economy for millions of vehicles and can conveniently be used by millions of drivers are of vital public, economic and commercial importance.

It would be desirable to address some or all of the various above-mentioned problems and issues, among others.

### SUMMARY OF THE INVENTION

Generally, a form of the invention involves a cruise control that includes an input for speed-related data, a hill angle sensor, and a cruise controller having a throttling control output and control conditions responsive to both the speed-related data and to the hill angle sensor to determine whether to increase or decrease a throttling control output or leave the throttling control output unchanged.

Generally, a cruise control process form of the invention involves executing control conditions responsive to both speed-related data and to a hill angle to determine whether to increase or decrease a throttling control output or leave the throttling control output unchanged.

Generally, another form of the invention involves an automotive vehicle that includes a torque producing assembly, wheels coupled to receive torque from said torque producing assembly, a braking assembly coupled with one or more of the wheels, a vehicle speed sensor, a hill angle sensor, and a cruise controller operable to control torque production by the torque producing assembly and said cruise controller having control conditions responsive to both speed-related data from said vehicle speed sensor and to hill angle-related data from said hill angle sensor to determine whether to increase or decrease wheel speed or leave the wheel speed unchanged and whether to activate said braking assembly.

Other cruise control apparatus and processes and automotive vehicles are disclosed and claimed.

### BRIEF DESCRIPTION OF THE DRAWINGS

FIG. 1 is a simplified profile view of an automotive vehicle on a hilly road improved as shown in the other Figures.

FIG. 2 is a graph of vehicle speed versus time along the road of FIG. 1 according to an inventive Economy mode.

FIG. 3 is a graph of vehicle speed versus time along the road of FIG. 1 in a Normal mode according to an inventive combination with the Economy mode of FIG. 2.

FIG. 4 is a pictorial diagram of a driver-operable area in the automotive vehicle of FIG. 1 and showing an inventive cruise control with cruise control actuator and mode display.

FIG. 5 is a block diagram of an inventive fuel economy optimized automotive cruise control structure operable as depicted in FIG. 6 or FIGS. 9A/9B.

FIG. 6 is a flow diagram of an inventive cruise control process of operating the inventive cruise control structure of FIG. 5.

FIGS. 7A and 7B are angle diagrams representing two varieties of output of a hill angle sensor in the inventive cruise control structure of FIG. 5.

FIG. 7C is another simplified profile view of a hilly roadway terrain to show various angle diagrams representing three varieties of output of the hill angle sensor in the inventive cruise control structure of FIG. 5.

FIG. 8 is another simplified profile view of a hilly road to describe a hypothetical performance scenario for using and testing an inventive process of operation of Economy mode.

FIGS. 9A and 9B are two parts of a composite flow diagram of another inventive cruise control process embodiment of operating the inventive cruise control structure of FIG. 5.

FIG. 10 is a block diagram of an inventive cruise control system applied in automotive systems utilizing teachings of this disclosure.

Corresponding numerals or letter symbols in different Figures indicate corresponding parts except where the context indicates otherwise.

### DETAILED DESCRIPTION

To solve the above-mentioned problems and others, various embodiments realize remarkable cruise control processes and cruise control structures. Some benefits and advantages of the embodiments include fuel economy, high performance, driver convenience, reliability, low cost, applicability to a wide variety of vehicles, and compatibility with many different engine types and braking technologies.

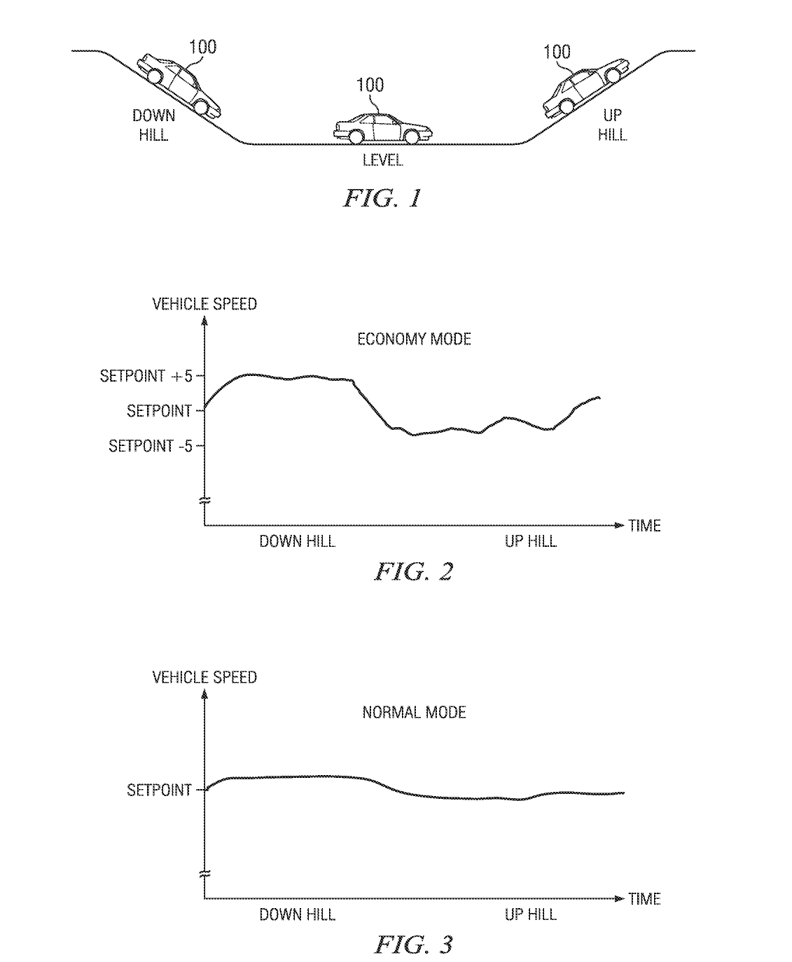

Conventional cruise control simply applies control directed to the set point and targeted to keep the vehicle 100 moving at a constant speed regardless of throttle position and incline. Such control may use the vehicle brakes or transmission to slow the car as it moves down hill in FIG. 1, which thereby dissipates energy to keep the vehicle speed from going above the set point. This operation also consumes and dissipates additional energy to slow the vehicle down and prevents or prohibits the generation of additional kinetic energy that can be used on the next up hill portion of the road.

By contrast, a category of embodiments involve a fuel economy optimized automotive cruise control, which employs any of various process embodiments or methods that automatically can keep a vehicle moving at the same average speed over a long distance while optimizing throttle position and fuel usage.

In FIG. 2, such embodiments allow the vehicle to stay within certain statically or dynamically specified limits defining a range around a desired cruise speed (referred to as “Economy mode” herein) to take advantage of down hill slopes in the terrain. When the vehicle is moving down an incline, the system allows the speed to increase slightly or somewhat above the cruise set point and in the defined range. When the vehicle is moving up an incline, the system allows the speed to decrease slightly or somewhat below the set point and in the defined range before applying additional throttle. In FIG. 2, the range is represented by [Setpoint−5 mph: Setpoint+5 mph], without limitation as to the amount, constancy or variability, or symmetry or assymetry of the range and range ends relative to the driver's Setpoint. Thus, such fuel economy optimized automotive cruise control embodiment here can automatically keep the vehicle moving at the same average speed over a long distance while optimizing throttle position and fuel usage. Advantages of various embodiments include performance and economy wherein the vehicle achieves better fuel economy without sacrificing the convenience of using the cruise control.

This Economy mode cruise control also is applicable to and may, but need not necessarily, be modified to work with not only a conventional gasoline or diesel engine vehicle but also a hybrid gas/electric vehicle; a methane or propane LPG injected vehicle; or battery or fuel cell powered electric vehicle. The Economy mode benefits a gasoline-only or diesel-only engine vehicle by using the vehicle mass as a high-efficiency energy store. The Economy mode actually also benefits a hybrid gas/electric, methane or propane or electric-only vehicle by using the vehicle mass as such a high-efficiency energy store instead of or in addition to the battery as the energy store in such vehicles. The Economy mode of the enhanced cruise control vehicular system stores energy in the down hill portion of the road in the form of additional vehicle speed/momentum/kinetic energy analogous to the manner that a hybrid/electric vehicle stores energy in a battery/capacitor when the vehicle slows down or stops. The Economy mode embodiments complement the fuel saving technology in a hybrid vehicle and reduce load on the charge/discharge hardware in the vehicle. The automotive vehicle 100 thus has some torque producing assembly, wheels coupled to receive torque from the torque producing assembly, and a braking assembly coupled with one or more of the wheels. “Throttle” and “throttling” herein refer to any structure and process to vary the amount or rate of energy, power, torque and/or angular velocity delivered by energy-delivering apparatus such as an engine or electrical energy source.

The system with Economy mode herein is beneficially used in an analogous manner on a vehicle with regenerative braking as on a vehicle with frictional brakes. Regenerative braking converts automotive kinetic energy into electrical energy and then into battery chemical energy and then reverses both those conversions later to recover kinetic energy.

Some embodiments and/or threshold parameters for Economy mode best benefit cars with frictional drum brakes or disc brakes, and other embodiments and/or threshold parameters for Economy mode best benefit a vehicle with regenerative braking. However, using Economy mode takes advantage of potential energy in the form of greater speed (momentum) of the mass of the car and is more efficient than slowing the vehicle by regenerative braking that converts and stores the kinetic energy in a battery instead. In other words, the conversion efficiency of direct conversion of kinetic energy to gravitational potential energy using Economy mode herein is greater than the conversion efficiency of regenerative braking. In regenerative braking, compared to Economy mode, the regenerative conversion efficiency is diminished by dissipative energy losses involved at all steps in converting the automotive kinetic energy into electrical energy and then converting into battery chemical energy and then reversing both those conversions later to recover the kinetic energy.

Some embodiments of fuel economy optimized automotive cruise control herein have at least two user-selectable modes: 1) a Normal mode as in FIG. 3 directed to the set point wherein the range ends [Setpoint−0: Setpoint+0] are at the setpoint itself and targeted to keep the vehicle moving at a constant speed, and 2) an Economy mode as in FIG. 2 and other Figures described herein to allow the vehicle to stay within certain limits defining a range given by Equation (1) around a desired cruise speed Setpoint:

[L:H]=[Setpoint−δ:Setpoint+ε]. (1)

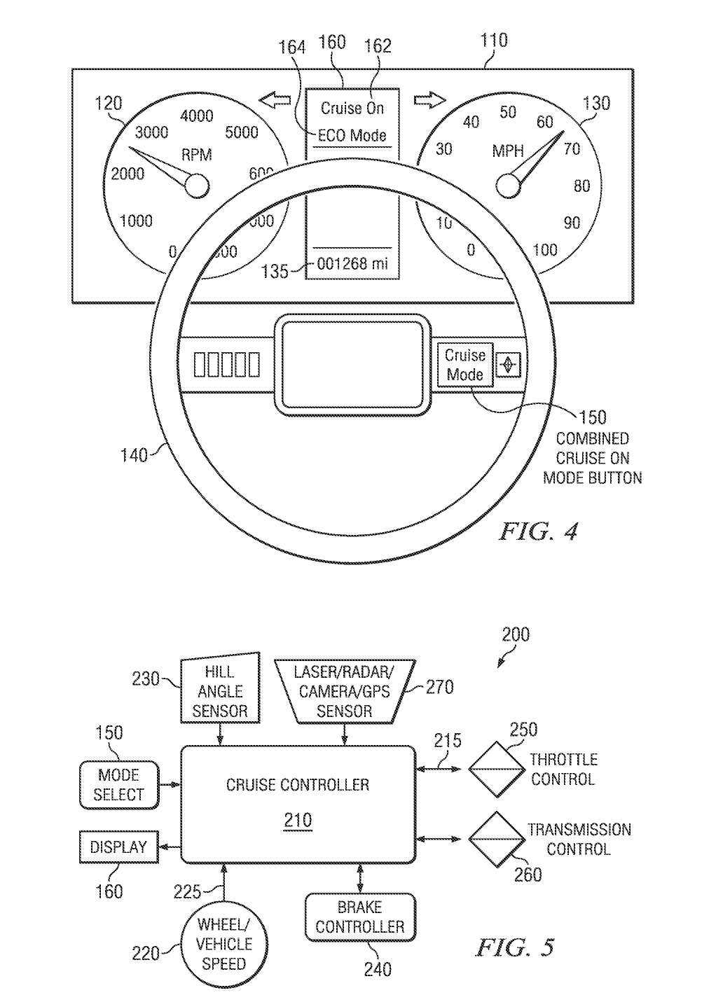

In FIG. 4, the automotive vehicle 100 of FIG. 1 has a driver's dashboard 110 with tachometer 120, speedometer 130 and odometer 135, a steering wheel 140 and a driver-usable cruise control actuator/mode selector 150, such as a combined Cruise-Normal/Economy/Off Mode button that cycles through Normal, Economy, and Off in response to successive manual button-pushes. The dashboard 110 includes a cruise mode display 160 having a display line 162 showing Off or On and a Mode line 164 showing Economy or Normal when the display line 162 shows On, or showing nothing (blank) when cruise display line 162 displays Off:

CRUISE ON/ON/OFF

ECO/NORMAL/<blank> (2)

If desired, a dedicated extra Mode button is suitably provided along with a Cruise Off/On button in some embodiments. Having a button as above that cycles through Normal, Economy, and Off in response to successive manual button-pushes inexpensively has no extra button to switch between Normal mode and Economy mode. The system controller suitably uses and monitors such a single button or lever on the steering wheel or on a cruise control stick and switches between the following modes with each manual button-push or lever-press. OFF→ON NORMAL MODE→ON ECONOMY MODE. The current selected mode is indicated by an indicator light in the vehicle instrument cluster via an informational display (LCD/LED) on dashboard 110, or on steering wheel 140, or on a center console display, or on a transparent organic film semiconductor display on the windshield of vehicle 100 or elsewhere.

Some embodiments alternatively or additionally provide a mode such as a Minimum Speed mode to set a range low end and leave the range high end indefinite. Another mode herein called an Anti-Tailgate mode responds to forward closing distance and rear closing distance.

On steering wheel 140, any other suitable driver-usable cruise control buttons are provided, such as Reset, Accelerate, Coast, and/or any other suitable buttons.

In FIG. 5, a cruise control system embodiment 200 has driver-usable cruise control actuator/mode selector 150, a cruise controller 210 and a vehicle wheel speed sensor 220 coupled to an input 225 for speed-related data to the cruise controller 210. Note that “wheel speed” sensing herein includes not only actual road speed determination but any measurement that is proportional thereto, or even a substantially monotonic function thereof, such as rpm (revolutions per minute) of an axle or crankshaft or otherwise. Cruise controller 210 is responsive to cruise control actuator 150 and operates, on moving down an incline sensed by a hill angle sensor 230, to allow speed to increase above a cruise Setpoint in the defined range [L=Setpoint−δ:H=Setpoint+ε]. A braking controller 240 and/or transmission control 260 is responsive to cruise controller 210 to apply the brakes if the speed increases above the high end (Setpoint+ε) of the defined range to maintain speed at and restrain speed to that high end. Such application of brakes is suitably made or left subject to any anti-skid brake technology or features of the vehicle, and the cruise control in some embodiments applies a more intensive throttle decrease instead of brakes if compatible with such anti-skid technology. If the incline downward diminishes or levels off so that the speed falls, then the speed may vary in the defined range. Cruise controller 210 operates to allow the speed to decrease below the Setpoint as well in the defined range, such as upon moving up a subsequent incline, or due to any physical condition involving kinetic energy dissipation. An energy source controller such as a throttle control 250 is responsive to a throttle control output 215 from cruise controller 210 to apply energy if the speed decreases below the low end Setpoint−δ of the defined range to maintain speed at that low end. If the incline upward levels off or diminishes so that the speed increases, then again the speed may vary in the defined range.

Even when the average speed is controlled to be the same in Normal mode and Economy mode, the remarkable fuel economy optimized automotive cruise control nevertheless confers fuel economy in Economy mode relative to the fuel consumption in Normal mode. Put another way, allowing the variability and variance of the cruise controlled vehicle speed to be established relative to range limits confers a reduction in fuel consumption. The Economy mode of the cruise control takes advantage of the vehicle momentum and potential energy as it goes down a hill by allowing the vehicle to go somewhat or slightly above the set point. This allows the vehicle to build up additional kinetic energy that can be used by the vehicle as it moves up the next hill.

On roads that have several short distance up hill and down portions the Economy mode takes full advantage, allowing the vehicle speed to increase above the set point and vary within the controlled range and thereby build up kinetic energy on down hill portions and letting the vehicle expend that energy on the up hill portions. The Economy mode also allows the vehicle to drop below the set point and vary within the controlled range on up hill portions. Compared to Normal mode, the Economy mode prevents the vehicle from immediately using more fuel just to keep an exact constant speed every time an up hill portion of road is encountered.

The remarkable Economy mode herein stores energy as kinetic energy in the mass of the vehicle, and fuel is saved when the vehicle is going down a descending incline and gravity speeds up the vehicle somewhat above the set point. Subsequently, this kinetic energy is used in lieu of fuel to keep the vehicle moving in the cruise control range if the road is level thereafter, or is instead converted into potential energy as the vehicle slows somewhat and ascends along a subsequent incline. By using the substantial mass of the vehicle as an energy storage element and no-extra-cost reservoir, fuel is saved in Economy mode relative to Normal mode, even given the same average vehicle speed over time.

A Hill Angle Sensor 230, has a physical, mechanical or solid state sensor, such as any of a tilt sensor, an inclinometer, clinometer, declinometer, slope sensor, gradient sensor, or pitch sensor or the like, to provide a fast-acting indication of probable effect on speed due to the terrain without waiting for a differencing operation on data from the wheel speed sensor 220. Hill Angle Sensor 230 in some embodiments is realized by a “sensorless” arrangement, such as one in which engine torque and kinematic variables sensed by pre-existing sensors in the vehicle architecture are processed by software to generate a hill angle or monotonic function thereof. Accordingly, the term “hill angle sensor” should be understood to include a variety of technologies for it. Notice that the information most likely pertinent to the cruise control is vehicle pitch data pertaining to the component of terrain altitude gradient vector ∇h parallel to the velocity vector v of the vehicle that for cruise control purposes is generally oriented the same as the rear-to-forward central or longitudinal axis of the vehicle. Mathematically, such Hill Angle Sensor 230 data of interest is basically related to the pitch angle θ of the vehicle or to some monotonic function of the ratio of the vertical component of velocity (with up and down+/−sign included) divided by the horizontal component of velocity.

θ=arctan [vᵥ/vₕ]

Some sensors may provide additional information such as tilt or roll in a direction transverse to the vehicle such as due to banking of a highway. While some embodiments may use transverse tilt or roll angle for cruise control itself in connection with curve-handling or anti-skid or anti-rollover support, others of the described cruise control embodiments operate independently of transverse tilt and roll angle and are so arranged. Also, such anti-skid and anti-rollover support are provided elsewhere in the vehicle if and as desired.

Appropriate damping in the Hill Angle Sensor 230 prevents error effects from speed bumps, washboard pavement speed warnings, road cracks or potholes. Some forms of Hill Angle Sensor 230 have a suspended ball-shaped mass in oil, a magnetically-sensitive suspended mass, a miniature gimbal-mounted gyroscope, an electrical, magnetic or optical sensor, or other suitable construction which may be accompanied by electronic processing and statistical filtering. Use of such Hill Angle Sensor 230 beneficially substitutes for a fuel flow sensor for high reliability since fuel flow and acceleration may not be very highly correlated. Also, structures for communication between a fuel flow sensor and the cruise controller 210 are eliminated, which reduces costs in the system. Instead, Hill Angle Sensor 230 is directly coupled to the cruise controller 210. Note also that some embodiments have no accelerometer used at all or instead speed change data is only conditionally used in conjunction with Hill Angle Sensor 230. The reason for this is to avoid cancelling controls due to the external information from Hill Angle Sensor 230 that could be cancelled by an accelerometer affected by internally-produced engine speed changes themselves.

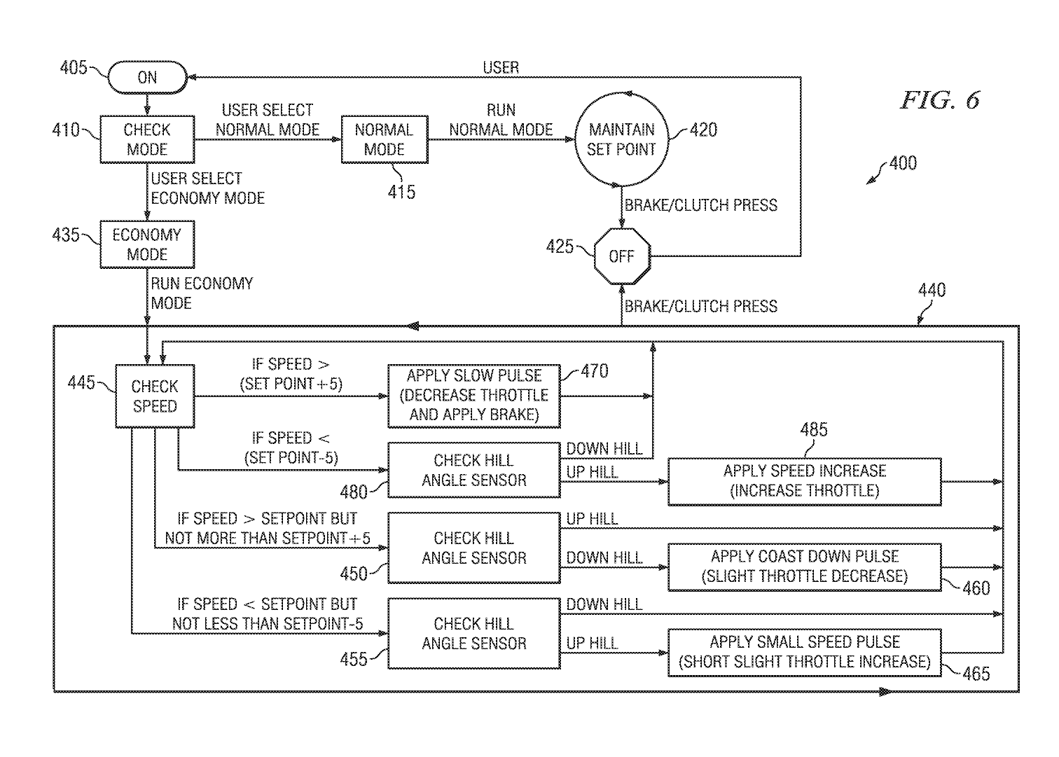

In FIG. 6, an operational flowchart shows a process embodiment of the response to the cruise control button(s) 150 of FIGS. 4 and 5. A cruise control button-push ON 405 commences operations employing a check mode 410 to further monitor the cruise control button for one or more further button-pushes or touch sensor presses. If one button-push, the process goes to a Normal mode 415 to run a Normal mode setpoint-holding procedure that involves a loop 420 to maintain the vehicle speed at or near the Setpoint as depicted in FIG. 3. Pressing the brake pedal (or clutch pedal if any) initiates a transition from any point in loop 420 to an OFF state 425 of the cruise control process. User can activate the cruise control again when desired, and a transition goes from OFF 425 to ON 405.

If check mode 410 detected two button-pushes instead, the process goes from check mode 410 to Economy mode 435 and executes Economy mode process 440. Pressing the brake pedal (or clutch pedal if any) initiates a transition from any point in loop 440 to OFF state 425 of the cruise control process. In process 440, a step 445 checks FIG. 5 wheel speed sensor 220 to determine the vehicle speed variable Speed. (Wheel speed sensor 220 suitably is the same sensor used to supply speed data for the speedometer 130.) If Speed exceeds Setpoint, but not more than range high end H=Setpoint+ε, then operations go to a step 450 to check the Hill Angle Sensor 230. If a condition designated “Up Hill” is detected, then operations loop back to Check Speed step 445. If a condition designated “Down Hill” is detected at step 450, then operations instead go to a step 460 and apply a predetermined throttle decrease called a Coast Down Pulse herein, and then loop back to Check Speed step 445. Some embodiments proportion the predetermined throttle decrease, such as by reducing a number or length of the Coast Down Pulse more aggressively for a steeper down-hill slope. This FIG. 6 embodiment uses cycles of steps 460, 445, 450, 460, etc., to cumulatively handle different degrees of steepness down hill. No fuel sensor communication with the process is needed.

If Speed is less than Setpoint, but Speed is not less than range low end L=Setpoint−δ, then operations go to a step 455 to check the Hill Angle Sensor 230. If a condition designated “Down Hill” is detected at step 455, then operations loop back to Check Speed step 445. If a condition designated “Up Hill” is detected at step 455, then operations instead go to a step 465 and apply a predetermined throttle increase called a Small Speed Pulse herein, and then loop back to Check Speed step 445. Some embodiments proportion the predetermined throttle increase, such as by increasing a number or length of the Small Speed Pulse more aggressively for a steeper up-hill slope. This FIG. 6 embodiment uses cycles of steps 465, 445, 455, 465, etc., to cumulatively handle different degrees of steepness up hill.

Further in FIG. 6 Economy mode procedure 440 has cruise control operations to more vigorously constrain vehicle Speed to speeds within the specified range. At Check Speed step 445, if Speed exceeds range high end H=Setpoint+ε, then operations go to a step 470 to generate a control signal Slow Pulse herein. Slow Pulse causes a further or more intensive predetermined throttle decrease to FIG. 5 Throttle Control 250 and may also signal Brake Controller 240 to apply brake, subject to anti-skid brake technology or features, whereupon operations then loop back to Check Speed step 445. This Slow Pulse is suitably arranged to effect a larger controlled reduction on throttle than the Coast Down Pulse of step 460. The loop 445, 470, 445, 470 adjusts the speed effectively until Speed no longer exceeds range high end H=Setpoint+ε, and operations then go to one of the earlier steps 450 or 455 described hereinabove. Also at step 470, some embodiments employ the Hill Angle Sensor 230 to proportion the predetermined throttle decrease or number or length of the Slow Pulse more aggressively for a steeper down-hill slope. The application of Slow Pulse to Brake Controller 240 in some embodiments is also conditioned on such steepness so that the brakes are used even more sparingly, whereby economy is further enhanced while maintaining effectiveness of speed control.

On the other hand, if Speed at step 445 were less than range low end L=Setpoint−δ, then operations instead go to a step 480 to check the Hill Angle Sensor 230. If a condition designated “Down Hill” is detected at step 480, then operations loop back to Check Speed step 445. If a condition designated “Up Hill” is instead detected at step 480, then operations go from step 480 to a step 485 and apply a predetermined throttle increase called a Speed Increase Pulse herein, and then loop back to Check Speed step 445. This Speed Increase Pulse is arranged to have a larger effect on throttle control than the Small Speed Pulse of step 465. Some embodiments proportion the predetermined throttle increase or number or length of the Speed Increase Pulse at step 485 more aggressively for a steeper up-hill slope.

In FIG. 6, repeated looping from step 445 through the various steps 470, 480, 485 of Economy mode procedure 440 effectuates cruise control operations that cooperate to vigorously constrain and/or vigorously bring vehicle speed into the specified speed range when necessary, using steps 470, 480, 485. In addition, steps 450, 460 and steps 455, 465 serve as a moderate inward forcing function to approximately center or otherwise keep the speed in the specified range. Moreover, steps 450, 460 and steps 455, 465 serve to reduce the number of occasions when the more vigorous constraining steps 470, 480, 485 would otherwise be employed, and thereby reduce the frequency of those vigorous throttle control events and reduce the incidence and operating expense of brake wear over time.

Parameters of pulse amplitude, pulse rate, pulse width, number of pulses, or otherwise are suitably configured and used in various embodiments of the circuitry and software to vary and establish Slow Pulse, Speed Increase, Coast Down Pulse, and Small Speed Pulse. Control Equations (3)-(6) define and control the parameters of each of the pulse controls: Slow Pulse, Speed Increase, Coast Down Pulse, and Small Speed Pulse. The exact control parameter values are made vehicle-specific. One, some, or all of the three PID control feedback components proportional, integral, derivative is or are suitably employed in an error-minimizing feedback loop to control the vehicle speed and drive-to-zero its departure from Setpoint (Normal mode). In Economy mode, the feedback loop is arranged to take moderate measures to reduce departure from Setpoint if in the specified range, else to take more aggressive measures to bring Speed into the specified range if Speed is outside, or has overstepped and departed from, the specified range.

In one example, the control parameters for use in FIG. 6 are as follows. In reading the control Equations (3)-(6), vehicle throttle positions are given in numbers 0 thru 100 (0=no throttle, 100=max throttle). Vehicle brake positions are given in numbers 0 thru 100 (0=brakes off, 100=max brake pressure).

Coast Down Pulse:

New Throttle Position=Current Throttle Position−2% (3)

Slow Pulse:

New Throttle Position=Current Throttle Position−5% (4)

Brake application for 2 sec at brake position 10 subject to anti-skid brake technology or features.

Small Speed Pulse:

New Throttle Position=Current Throttle Position+2% for a duration of 2 seconds, then return to previous throttle position. (5)

Speed Increase:

New Throttle Position=Current Throttle Position+5% (6)

A throttle position sensor may be coupled to cruise controller 210 in some embodiments for cruise controller 210 to perform the calculations and issue a throttle control signal to throttle control 250. Other embodiments dispense with such coupling by pre-establishing the pulses to have a length or value adapted to the type of throttle controller to substantially accomplish Equations (3)-(6). Cumulative pulse control as discussed hereinabove makes the pulse control even more effective.

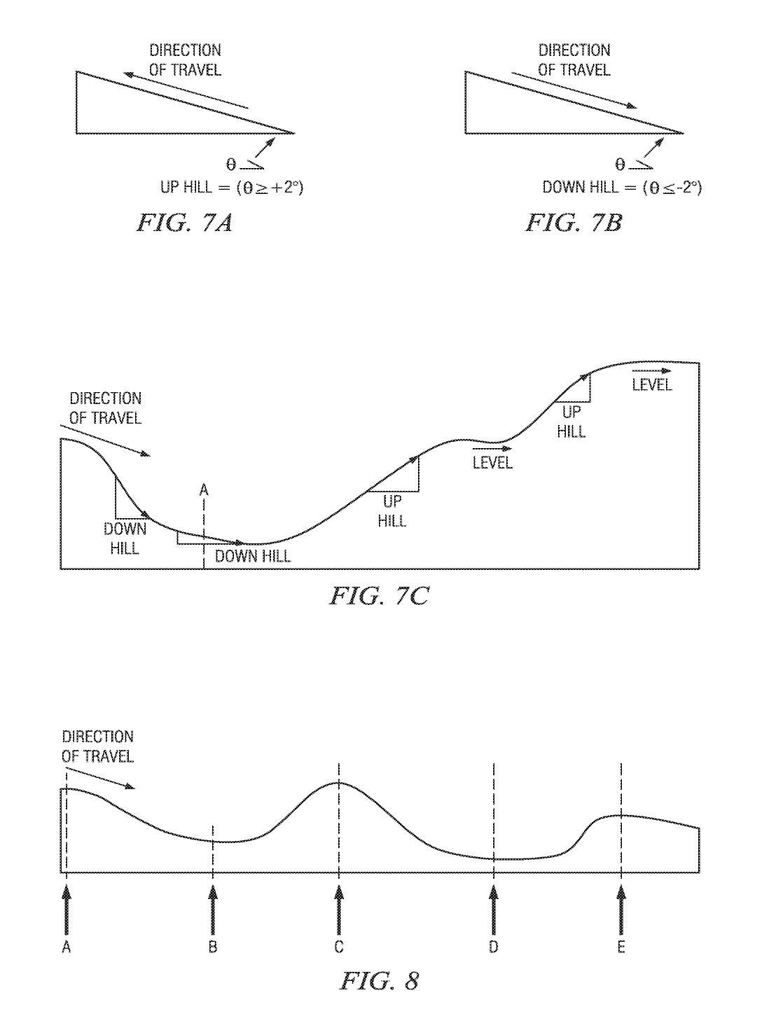

FIGS. 7A, 7B, and 7C illustrate FIG. 6 operations 450, 455, 480 based on the FIG. 5 Hill Angle sensor 230. Some embodiments can perform actual angle-related operations by an instance of sensor 230 that generates fine-grained angle-related information that can be used directly in PID continuous-angle control embodiments. Thresholding applied to the fine-grained angle-related information provides Up/Down or Up/Level/Down output for PID or other forms of control flows. In some other embodiments, the sensor itself coarsely provides Up/Down or Up/Level/Down output only. The Hill Angle Sensor 230 is used to determine if the cruise control system should apply additional speed, or deceleration, or no action, to the vehicle based on the current angle of travel.

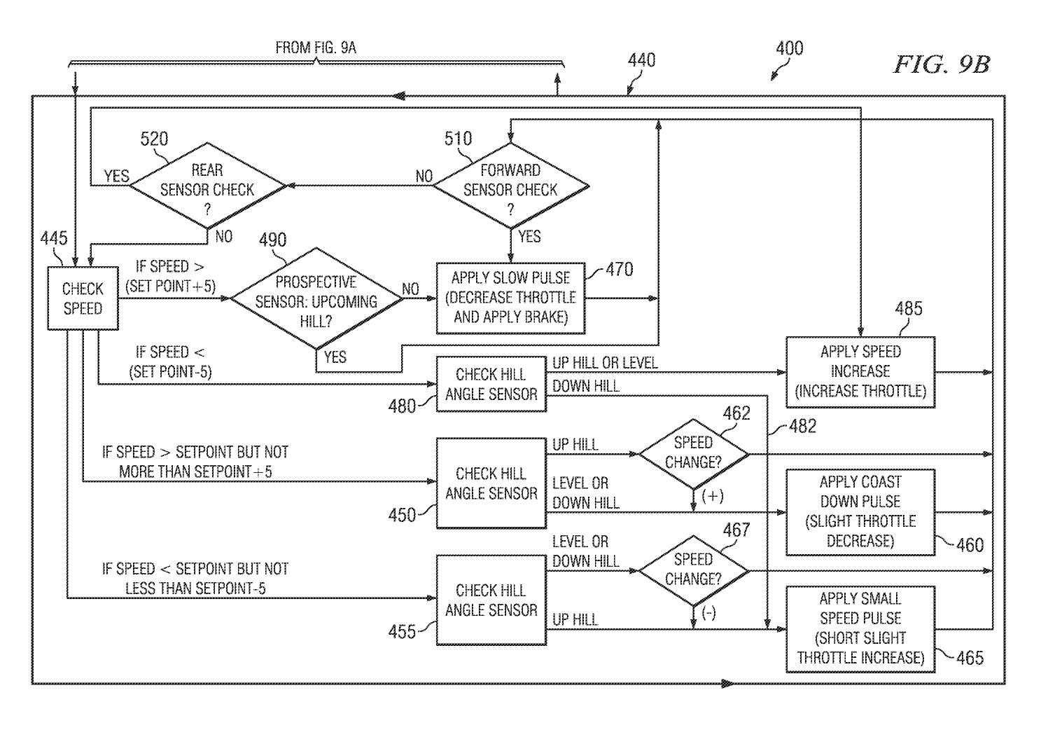

Defining Up Hill and Down Hill can be useful because, if the Hill angle is slightly downhill (negative) but still insufficient to overcome the automobile motor slowing down of its own accord, some embodiments can be arranged to recognize that that inclination is not Down Hill for purposes of Economy mode. Thus, an embodiment having binary Up Hill and Down Hill outputs might be configured to recognize a small negative Hill angle as Up Hill for purposes of Economy mode, or for another car to recognize a small uphill (positive) Hill angle as Down Hill. Thus data from actual testing of a vehicle model on which the Economy mode cruise control is being implemented is useful to determine the exact hill angle parameters that are entered in a parameter memory or in software code to determine the conditions that activate particular Up Hill or Down Hill outputs from each particular step 450, 455 or 480. Also, an embodiment with Hill Angle Sensor 230 that has an intermediate Level output may have flow lines relating to Level emanating from steps 450, 455, and 480 variously arranged for different vehicle types than shown in FIG. 6 or 9B without departing from the teachings herein. Some examples of possible Up Hill and Down Hill definitions are shown next:

Up Hill=Any angle A greater than a threshold ThU such as 2 degrees as the vehicle is traveling up an incline as in FIG. 7A. The decision criterion is A>ThU. ThU is positive in this example but need not be.

Down Hill=Any angle less than ThD such as −2 deg as the vehicle is traveling down an incline as in FIG. 7B. The decision criterion is A<ThD. ThD is negative in this example but need not be.

Level: The flow diagram of FIGS. 9A/9B shows a flow including control operations employing a middle range output designated “Level” that recognizes when the car is going neither Up Hill or Down Hill in FIG. 7C and instead lies within ThD<=A<=ThU, e.g. −2 to +2 degrees.

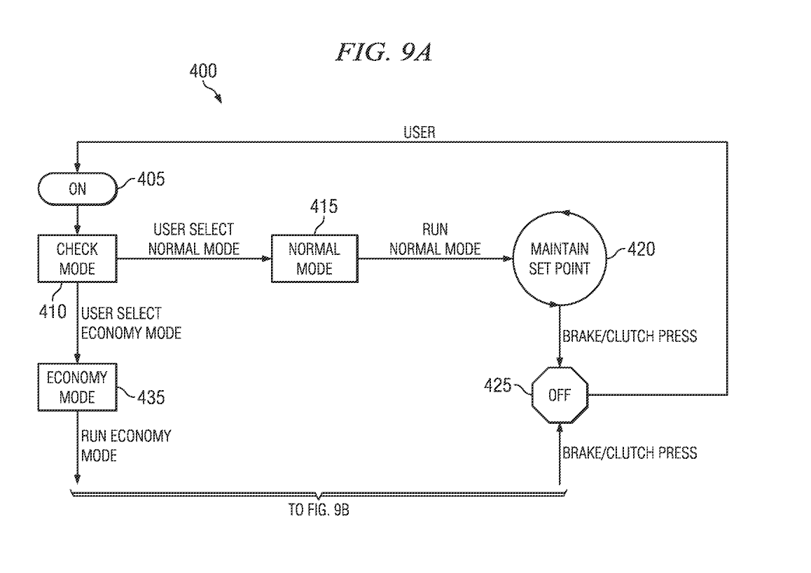

FIG. 8 and TABLES 1-3 together depict various hypothetical performances and net fuel economy outcomes over an averaging time interval, and provide a template for test purposes. The Economy mode is expected to be most efficient on a road with rolling hills. This FIG. 8 example hypothetically illustrates the Economy mode fuel savings in one topographic scenario compared with the Normal mode of the cruise control system. In TABLE 1, on a level wind-free road surface, the Normal mode operation per unit incremental fuel consumption is 1.0 by definition over five equally spaced distance intervals ending at points A, B, C, D, E, and the speed is uniform at 55 mph.

TABLE 1
NORMAL MODE OPERATION
(LEVEL SURFACE)

| Position | A | B | C | D | E | Average |
|---|---|---|---|---|---|---|
| Speed | 55 | 55 | 55 | 55 | 55 | 55 |
| Cumulative | 1.0 | 2.0 | 3.0 | 4.0 | 5.0 | 1.0 |
| Fuel Consumed | | | | | | |
| Incremental | 1.0 | 1.0 | 1.0 | 1.0 | 1.0 | N/A |
| Fuel Consumed | | | | | | |

TABLE 2
NORMAL MODE OPERATION
(FIG. 8 SURFACE HYPOTHETICAL)

| Position | A | B | C | D | E | Average |
|---|---|---|---|---|---|---|
| Speed | 55 | 55 | 55 | 55 | 55 | 55 |
| Cumulative | 1.0 | 1.9 | 3.2 | 3.7 | 4.8 | 0.96 |
| Fuel Consumed | | | | | | |
| Incremental | 1.0 | 0.9 | 1.3 | 0.5 | 1.1 | N/A |
| Fuel Consumed | | | | | | |

In TABLE 2, on a rolling wind-free topography, the Normal mode operation has per unit incremental fuel consumption that is 1.0 on the level, less than 1.0 on downhill and more than 1.0 on uphill, and the speed is again substantially uniform at 55 mph here due to cruise control Normal mode. Therefore the average speed is 55 mph too. On downhill, the deceleration of the vehicle is dissipated into heat of braking and transmission loss in case of a non-hybrid, and partially dissipated if hybrid. Accordingly, considerable fuel is expended on uphill to maintain the speed at 55 mph. Note that Normal mode in FIG. 8 and TABLE 2 is tabulated to have a little less fuel consumed than on the level of TABLE 1 to reflect the net downhill trend. (More fuel would be consumed than on level if FIG. 8 had an uphill trend.)

TABLE 3
ECONOMY MODE OPERATION
(FIG. 8 SURFACE HYPOTHETICAL)

| Position | A | B | C | D | E | Average |
|---|---|---|---|---|---|---|
| Speed | 55 | 59 | 51 | 60 | 50 | 55 |
| Cumulative | 1.0 | 1.9 | 3.0 | 3.5 | 4.5 | 0.90 |
| Fuel Consumed | | | | | | |
| Incremental | 1.0 | 0.9 | 1.1 | 0.5 | 1.0 | N/A |
| Fuel Consumed | | | | | | |

In TABLE 3, on the same rolling, wind-free topography, the Economy mode operation is qualitatively different in that the speed varies in a controlled manner over a range 50-60 mph bounding the Setpoint. The average speed is still 55, but the speeds in individual sections of the road can vary over a +/−5 mph range. On downhill, the deceleration of the vehicle is more largely and desirably converted into kinetic energy using Economy mode and therefore its energy is far less dissipated into heat of braking and transmission in case of non-hybrid and less dissipated in the case of a hybrid. Accordingly, less fuel is expended on uphill (entries C and E in TABLE 3 are less than in TABLE 2) to maintain the speed because the kinetic energy from downhill motion assists the uphill motion. Note that Economy mode in FIG. 8 and TABLE 3 is tabulated to depict even less fuel consumed than on the level of TABLE 1 to reflect the net downhill trend, and shows a net hypothetical fuel savings compared to Normal mode of TABLE 2. If FIG. 8 had an uphill trend, then depending on the steepness, more fuel would be consumed in Economy mode than in downhill TABLE 3 but still less than the substantially more fuel that would be consumed in Normal mode.

In FIGS. 9A/9B, an embodiment further has 1) Speed sensing tests 462 and 467, 2) Small Speed Pulse response to Downhill at step 480, 3) three-way hill angle sensing, 4) dynamic adjustment of range ends in step 445, 5) prospective analysis by sensor(s) 270 at step 490, 6) forward closing distance sensing 510 and 7) Anti-tailgating 520.

Speed Sensing: As noted here, some control functions 462 and 467 are based on speed sensing, i.e. increase or decrease of Speed from wheel speed sensor 220. Suppose, for instance, that vehicle speed is in-range and well above the setpoint (e.g., Setpoint+4) and the car is going Up Hill at step 450 but Speed is nevertheless increasing (Speed Change 462 detects positive (+)). This condition might occur due to a tail wind or engine parameters. Then an additional decision step 462 detects this condition and branches to apply Coast Down Pulse 460 before looping back to Check Speed 445. Conversely, suppose the vehicle speed is in-range and well below the setpoint (e.g., Setpoint−4) and the car is level or going Down Hill at step 455, but the Speed is nevertheless decreasing (Speed Change 467 detects negative (−)). A head wind or different engine parameters might be responsible if this condition occurs. An additional decision step 467 detects this condition and branches to apply Small Speed Pulse 465 before looping back to Check Speed 445. If neither the condition of step 462 nor 467 is met, operations simply loop back directly to Check Speed 445. Since the simple loop back would amount to a delay of action anyway, a small delay in performing step 462 or 467 is acceptable if involved in this particular path. Some embodiments having step 462 or 467 or analogous control employ an electronic combination of MEMS (micro-electromechanical system) accelerometer and gyroscope with statistically-filtered corrections to provide tilt with acceleration and vibration filtered out. Some embodiments also supplement wheel speed sensor data and inclinometer tilt data with accelerometer data on at least the component of the acceleration vector parallel to vehicle velocity.

Small Speed Pulse Response: In another part of FIG. 9B, if Speed at step 445 is less than range low end L=Setpoint−δ, then operations go to a step 480 to check the Hill Angle Sensor 230. If a condition designated “Down Hill” is detected at step 480, then FIG. 9B operations branch via revised path 482 to step 465 to apply Small Speed Pulse before looping back to Check Speed step 445.

Three-Way Hill Angle Sensing: Step 480 is adapted to handle a three-way Up/Level/Down Hill Angle Sensor 230 output so that if Up Hill or Level is active, then step 485 applies a Speed Increase. If Level or Down Hill is active in step 450, then step 450 applies Coast Down Pulse step 460. If Level or Down Hill is active in step 455, then operations go to speed sensing step 462 in FIG. 9B.

In FIGS. 9A/9B generally, the exact system flows and formulas are suitably adapted if desired to optimally control different vehicle types, engine and transmission characteristics and vehicle weights. The flow diagrams are used to describe some embodiments of the system among others.

Dynamic Adjustment of Range Ends: To maintain the average speed in Economy mode in FIGS. 9A/9B, some embodiments dynamically adjust the range ends L and H for Economy mode as a function of the long term topography experienced or predicted by the vehicle. For instance, if the topography is generally downhill, then the range high end H is dynamically adjusted closer to the Setpoint, because otherwise the Economy mode would permit the vehicle to operate at the higher speed H on average. Conversely, if the topography is generally uphill, then the range low end L is dynamically adjusted closer to the Setpoint, because otherwise the Economy mode would permit the vehicle to operate at the lower speed L on average. The flow steps to dynamically adjust the range ends L and H for Economy mode are suitably provided as dynamic reconfiguration steps included in the Check Speed 445 block in FIG. 6 or FIGS. 9A/9B along with the speed condition determination or processing. Such adjustments are suitably made gradually based on data spanning at least several miles ahead, such as from survey and GPS topographic database information.

Prospective Analysis: In FIG. 9B, circuitry and flow elements helpfully operate Cruise control Economy mode in further beneficial ways. Consider a scenario in which the speed exceeds the setpoint+5 and the system would lose energy by applying brake on an Up Hill incline on which the speed of the car will decrease anyway and be economically converted into potential energy quite soon without braking Or suppose in this scenario that the car is approaching a hill that at first has a small Up Hill incline and then the much steeper Up Hill incline. It appears that system would apply the brakes wastefully on the small incline even though the much steeper Up Hill incline is only a little way ahead.

FIG. 9B shows an additional embodiment that would avoid losing energy braking in this scenario. Adding or enhancing the cruise control system with a forward looking sensor 270 (radar, laser, camera, GPS unit, etc. . . . ) can improve the fuel efficiency of the system by allowing the vehicle to scan the road conditions ahead. Indeed, using elevation information such from topographic maps or GPS elevation information coordinated with GPS position information and/or forward sensor position information can provide the exact position and elevation profile in the upcoming vicinity of the vehicle. In a condition in which the vehicle reaches Setpoint+5 but senses that the road conditions ahead include an extended ‘Up Hill’ slope, the cruise control system temporarily allows the vehicle to exceed the Setpoint+5 condition without applying the brake.

In FIGS. 7C and 9B, this condition is illustrated in the diagram of FIG. 7C where point ‘A’ is the position at which the vehicle would exceed the setpoint+5 condition, but be allowed to continue without issuing a Slow Pulse since the system senses a long ‘Up Hill’ condition ahead. In FIG. 9B, the flow includes a decision step 490 inserted ahead of the operation of issuing a Slow Pulse 470. In this way, if the forward sensor senses a long or sufficiently inclined ‘Up Hill’ condition ahead, then issuing a Slow Pulse 470 is bypassed and operations loop back to Check Speed 445. Otherwise issuing a Slow Pulse 470 is executed.

Forward Closing Distance Sensing: Further in FIGS. 9A/9B, suppose one's car is closing in distance too close in front to the car ahead or the car behind is closing distance too close to the rear of one's car. Conventional cruise control may involve such issues for drivers. The greater amount of speed variation in the Economy mode also leads to some treatment herein of the subject of closing distance.

In FIGS. 9B and 5, the system is further enhanced to take into account vehicles traveling in closer or farther proximity. Control steps based on the forward/rear sensor 270F/270R data are integrated with the control steps of FIG. 6. Each such sensors is suitably provided to sense vehicles or objects in the same lane of a multi-lane roadway as distinguished from any such vehicles in another lane. For example, a vehicle embodiment is equipped with forward/rear looking sensors (radar, laser, camera, etc. . . . ) 270 to provide sensor data acquired over time about vehicle(s) ahead and/or behind, as well as about any lane stripe(s), for analysis to detect their presence and distance. Motion around a curve is also detected so that vehicles in another lane and barrier material separating lanes do not cause unintended response by the cruise control. Also, sensor data such as transverse acceleration sensing of the driver's own vehicle can provide confirmatory data about a curve, recognizing such data may lag information obtained about curved motion of the vehicle ahead. Temporary loss of acquisition followed by re-acquisition of a vehicle ahead or behind such as on a curve or varying incline is handled with data averaging or memory. Software provides a distance measurement and an indication of the reliability of the vehicle detection and distance measurement. Operations suitably bypass or adjust the particular cruise control response to the Forward Closing Distance Sensing or Anti-Tailgating distance sensing and provides a warning buzz or other indication to driver if the information is ambiguous over a sufficient time interval to justify the warning.

In FIG. 9B, if another vehicle is sensed to be a certain distance closing ahead or closing behind, but still several car lengths ahead (e.g., 10-50 car lengths), the Economy mode control process at step 445 is suitably arranged to allow a smaller deviation from the set point in order to create a more accommodating environment for other drivers. Also, when the forward separation gets closer notwithstanding, e.g., 10 car lengths or less, an additional decision step 510 determines whether the forward sensor data indicate that the driver's vehicle is closing in on the vehicle ahead at a high-enough rate (negative rate of change of forward separation distance) exceeding a rate threshold or has reached a forward separation distance that is close enough to be exceeded by a distance threshold. Some embodiments make the rate threshold approximately proportional to forward separation distance. Another alternative compares a constant threshold to a ratio of negative rate of change of forward separation distance divided by forward separation distance. If the threshold is exceeded (Yes) in step 510, then operations branch to step 470 to apply a Slow Pulse. Some embodiments proportion the Slow Pulse to the just-stated ratio.

Anti-Tailgating: A further anti-tailgating decision step 520 is provided between step 510 (No) and Check Speed step 445 so that the cruise controller is conditionally responsive to a rear distance sensor to speed up unless the response to the forward distance sensor to slow down is active. In this way, Anti-Tailgating decision step 520 is subordinated to Forward Closing Distance Sensing step 510 in the case the vehicle is close to vehicles both ahead and behind (or perhaps is in dense fog). In a further subordination aspect, step 520 checks whether a Slow Pulse has just been issued or whether the condition for Slow Pulse in step 510 would be met using a conservatively lower threshold (e.g. 10% less). If so (No), operations proceed from step 520 (No) to Check Speed 445 to avoid issuing a Speed Increase immediately after the Slow Pulse and to avoid pumping the brakes and accelerator alternately. Otherwise, if Slow Pulse has not just been issued, Anti-Tailgating decision step 520 checks whether the rear sensor 270R data indicate that the vehicle behind is closing in on the driver's vehicle at a high-enough rate (negative rate of change of rear separation distance exceeding a rate threshold) or has reached a rear separation distance that is close enough to be exceeded by a distance threshold. Some embodiments make the rate threshold approximately proportional to rear separation distance, or compare a constant threshold to a ratio of negative rate of change of rear separation distance divided by rear separation distance. If the threshold is exceeded (Yes) in step 520, then operations branch to step 485 to apply a Speed Increase pulse. Some embodiments proportion the Speed Increase to the ratio of this paragraph. If the threshold is not exceeded (No) in step 520, then operations go back to Check Speed 445.

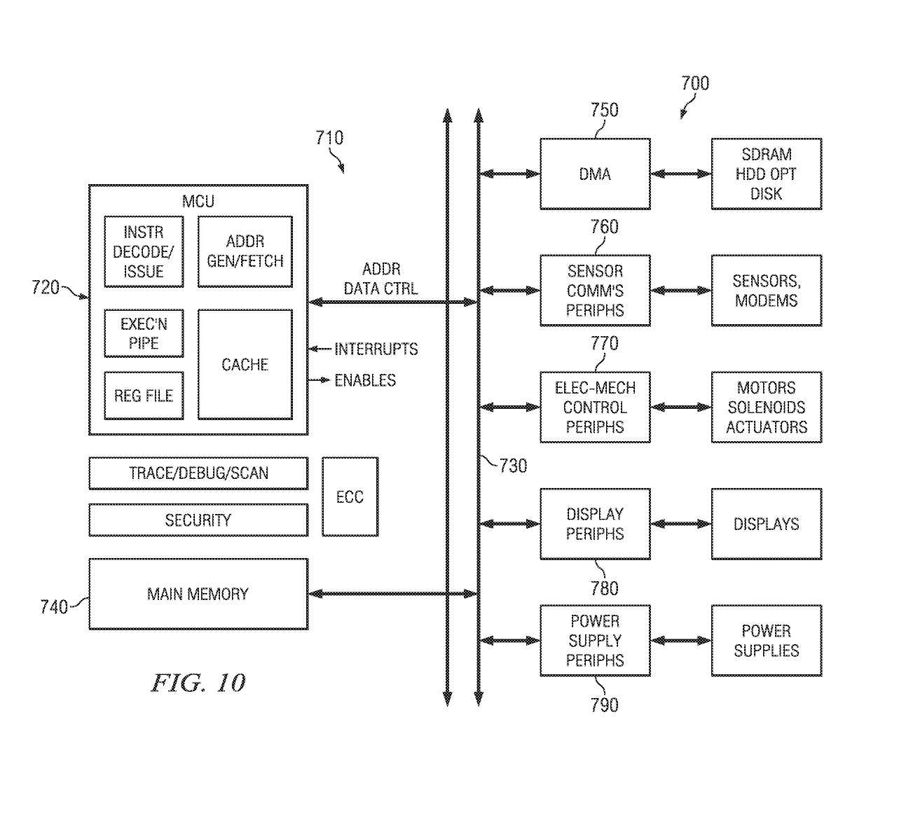

In FIG. 10, an example of a system 700 has a system-on-chip (SoC) 710 that includes a microcontroller MCU processor 720. For instance, MCU processor 720 has a pipelined CPU (central processing unit) with an address generator and fetch unit, instruction decode and issue unit, pipelined execution unit, register file, and cache memories unit. In various forms, the processor 720 is any of scalar, superscalar, multi-core, or other architecture. SoC 710 also has ECC (Error Correcting Code) support for demanding vehicular environments, security and Trace/Debug/Scan blocks. One or more buses 730 couple the CPU addresses, data and control lines with a main memory 740, a DMA (direct memory access) module 750, and data reception and communications peripherals 760. Peripheral(s) 760 are coupled to or include a data sensor such as Hill Angle Sensor 230 and Wheel Speed Sensor 220 and ADC (analog-to-digital converter) and modems (wireline and/or wireless). One or more electro-mechanical control peripherals 770 control motors, actuators, solenoids, and other controlled elements and systems such as for FIG. 5 throttle control 250 and brake controller 240, transmission control 260, and otherwise as appropriate for the vehicle. Display peripherals 780 control, and sense data from, lights, LEDs (light emitting diodes), control buttons and touch sensors such as Mode Select 150, cruise control display 160 and other display interfacing. Power supply peripherals 790 control power supply parameters, voltage regulation, power-level switching, smart power management on-chip and off-chip and other powered functions. The control peripherals for the vehicle generally are operative to control and sense automotive engine fuel and mixture, brakes, dashboard, passenger protection, door assemblies, and electrical system voltage regulation, switching and other electrical control. Speed sensing 220, hill angle sensor 230, camera and other imaging interfaces 270 together with satellite positioning sensing such as GPS, and wireless modems and other peripherals are thus supported and coupled to the system to effectuate the operations described herein. The system 700 is suitably supported by any of a variety of automotive microcontrollers, such as TMS470 or TMS570 microcontrollers from Texas Instruments TMS470PSF761A (or similar), or other microcontrollers.

Some vehicle embodiments are provided with automatic driving structures and in addition to or in lieu of the steering wheel 140, such as voice control, camera responsive driver control or otherwise. Likewise, the illustrated cruise control buttons herein may be supplemented with or replaced by voice control, and/or camera responsive controls for the driver to use. Further, dynamic forms of cruise control actuation and configuration that respond to sensor information about road conditions are also suitably provided as described elsewhere herein. Some remote control highway systems may take over the steering and acceleration and braking operations or constrain them within remote control parameters. Some embodiments of the cruise control are adapted to coordinate with such remote control highway systems and respond to driver options compatible with them.

Various embodiments of process and structure are provided in one or more integrated circuit chips, multichip modules (MCMs), device to device (D2D) technology, printed wiring media and printed circuit boards, vehicles and platforms.

Aspects (See Explanatory Notes at End of this Section)

1A. The cruise control claimed in claim 1 further comprising a wheel speed sensor coupled to said cruise controller via said input for speed-related data.

1A1. The cruise control claimed in claim 1A further comprising a throttle controller and said cruise controller is operable to one-way signal for throttle increase and decrease to said throttle controller and complete a control loop through said wheel speed sensor.

1B. The cruise control claimed in claim 1 wherein said cruise controller is operable to generate the throttling control output to substantially maintain an average speed by dynamically adjusting range ends of a speed range.

1C. The cruise control claimed in claim 1 wherein said cruise controller is responsive to the speed-related data in a cruise control mode to supply the throttling control output as a speed forcing-function toward a setpoint and also constraining speed from digressing below a lower endpoint lower than said set point.

1D. The cruise control claimed in claim 1 wherein said cruise controller is operable to substantially maintain an average speed by range end adjustment of a speed range.

1E. The cruise control claimed in claim 1 further comprising a cruise control actuator coupled to said cruise controller to establish driver-selectable cruise control modes, and a display responsive to said cruise controller to display a current cruise control mode.

1E1. The cruise control claimed in claim 1E wherein said display is responsive to said cruise controller to substantially display a mode as Economy or Normal when a cruise control function is active.

1F. The cruise control claimed in claim 1 wherein said cruise controller has a mode that responds to forward closing distance and rear closing distance.

1G. The cruise control claimed in claim 1 wherein said cruise controller is operable to proportion the throttle control output in relation to steepness of a slope as detected by said hill angle sensor.

1H. The cruise control claimed in claim 1 wherein said cruise controller is operable to cumulatively adjust the throttle control output to handle different degrees of steepness of a slope.

1J. The cruise control claimed in claim 1 further comprising a distance sensor, and said cruise controller is operable in response to said distance sensor to adjust the throttle control output based on closer or farther vehicular proximity.

1J1. The cruise control claimed in claim 1J wherein said cruise controller has a range for controlling speed and is operable based on proximity to restrain speed to a smaller range.

1J2. The cruise control claimed in claim 1J wherein said cruise controller is operable in case of closer proximity to adjust the throttle control output as a function both of separation distance and a rate of change of separation distance

2A. The cruise control claimed in claim 2 further comprising a braking controller responsive to said cruise controller to brake if the speed increases above a high end of the defined range.

2B. The cruise control claimed in claim 2 wherein said cruise controller is operable to adjust the throttling control if the speed decreases below a low end of the defined range to bring speed at least up to that low end.

9A. The cruise control claimed in claim 9 wherein said cruise controller is responsive to a Down Hill condition of input from said hill angle sensor to execute a third level of control including braking control to keep speed in that range when the speed is outside that range.

14A. The cruise control claimed in claim 14 wherein said cruise controller is operable so that if Speed exceeds the range high end, then generate the throttle control output for a more intensive throttle decrease.

14A1. The cruise control claimed in claim 14A wherein said cruise controller is operable further on a hill angle condition involving Down Hill so that if speed exceeds the range high end, to signal an application of brake subject to anti-skid braking.

21A. The cruise control process claimed in claim 21 further comprising one-way signaling for throttle increase and decrease and completing a control loop through wheel speed.

21B. The cruise control process claimed in claim 21 further comprising a forward distance sensor, wherein said cruise controller is responsive to the speed-related data in a cruise control mode to adjust the throttling control output to slow down in response to said forward distance sensor.

21B1. The cruise control process claimed in claim 21B further comprising a rear distance sensor, and said cruise controller is responsive to said rear distance sensor to speed up unless the response to said forward distance sensor to slow down is active.

21C. The cruise control process claimed in claim 21 further comprising a rear distance sensor, and said cruise controller is conditionally responsive to said rear distance sensor to adjust the throttling control output to speed up.

21D. The cruise control process claimed in claim 21 further comprising using a satellite positioning circuit to bypass application of brake.

21E. The cruise control process claimed in claim 21 further comprising operating if vehicle speed is in-range and above a setpoint and said hill angle represents Up Hill but speed is nevertheless increasing, then applying a throttle decrease.

21F. The cruise control process claimed in claim 21 further comprising operating if vehicle speed is in-range and below a setpoint and said hill angle represents Level or Down Hill but the speed is nevertheless decreasing, then applying a throttle increase.

Notes: Aspects are description paragraphs that might be offered as claims in patent prosecution. The above dependently-written Aspects have leading digits and may have internal dependency designations to indicate the claims or aspects to which they pertain. The leading digits and alphanumerics indicate the position in the ordering of claims at which they might be situated if offered as claims in prosecution.

A few preferred embodiments have been described in detail hereinabove. It is to be understood that the scope of the invention comprehends embodiments different from those described, as well as described embodiments, yet within the inventive scope. Microprocessor and microcomputer are synonymous herein. Processing circuitry comprehends digital, analog and mixed signal (digital/analog) integrated circuits, ASIC circuits, PALs, PLAs, decoders, memories, non-software based processors, microcontrollers and other circuitry, and digital computers including microprocessors and microcomputers of any architecture, or combinations thereof. Internal and external couplings and connections can be ohmic, capacitive, inductive, photonic, and direct or indirect via intervening circuits or otherwise as desirable. Implementation is contemplated in discrete components or fully integrated circuits in any materials family and combinations thereof. Various embodiments of the invention employ hardware, software or firmware. Process diagrams and block diagrams herein are both representative of flows and/or structures for operations of any embodiments whether of hardware, software, or firmware, and processes of manufacture thereof.

While this invention has been described with reference to illustrative embodiments, this description is not to be construed in a limiting sense. Various modifications and combinations of the illustrative embodiments, as well as other embodiments of the invention may be made. The terms “including”, “includes”, “having”, “has”, “with”, or variants thereof are used in the detailed description and/or the claims to denote non-exhaustive inclusion in a manner similar to the term “comprising”. It is therefore contemplated that the appended claims and their equivalents cover any such embodiments, modifications, and embodiments as fall within the true scope of the invention.

What is claimed is:

1. A cruise control system comprising:
(A) a controller having a throttle output, a mode select input, a GPS sensor input, a wheel speed input, a display output, a brake control output, and a transmission control output, the controller including a separate hill angle sensor input; and
(B) a hill angle sensor providing an angle signal on an output coupled to the hill angle sensor input, the angle signal providing fast acting, vehicle pitch data oriented to the longitudinal axis of a vehicle.

2. The cruise controller of claim 1 in which the hill angle sensor is any one of a mechanical or solid state sensor.

3. The cruise controller of claim 1 in which the hill angle sensor is any one of a tilt sensor, an inclinometer, clinometers, declinometer, slope sensor, gradient sensor, or pitch sensor.

4. The cruise controller of claim 1 in which the angle signal provides a pitch angle theta of the longitudinal axis of the vehicle.

5. The cruise controller of claim 1 in which the angle signal provides a pitch angle theta of the ratio of a vertical component of velocity of the vehicle divided by a horizontal component of velocity of the vehicle.

6. An automotive vehicle comprising:
(A) a vehicle having a longitudinal axis;
(B) a torque producing assembly coupled to the vehicle and having a torque sensor output and a torque control input;
(C) wheels coupled to the vehicle and to the torque producing assembly;
(D) a braking assembly coupled to the wheels and having a brake control input;
(E) a vehicle speed sensor coupled to the wheels and having a speed sensor output;
(F) a GPS sensor coupled to the vehicle and having a GPS output;
(G) a hill angle sensor coupled to the vehicle and providing an angle signal on a hill angle sensor output, the angle signal providing fast acting, vehicle pitch data oriented to the longitudinal axis of the vehicle; and
(H) a cruise controller having inputs coupled to the torque sensor output, the speed sensor output, the GPS output, and the hill angle sensor output, and having outputs coupled to the torque control input and the brake control input.

7. The cruise controller of claim 6 in which the hill angle sensor is any one of a mechanical or solid state sensor.

8. The cruise controller of claim 6 in which the hill angle sensor is any one of a tilt sensor, an inclinometer, clinometers, declinometer, slope sensor, gradient sensor, or pitch sensor.

9. The cruise controller of claim 6 in which the angle signal provides a pitch angle theta of the longitudinal axis of the vehicle.

10. The cruise controller of claim 6 in which the angle signal provides a pitch angle theta of the ratio of a vertical component of velocity of the vehicle divided by a horizontal component of velocity of the vehicle.
